(19) United States
(12) Patent Application Publication
(10) Pub. No.: US 2026/0142076 A1
(43) Pub. Date: May 21, 2026

(54) IRON-SILICON MAGNETIC POWDER CORE, PREPARATION METHOD THEREFOR, AND INDUCTOR

(71) Applicant: HENGDIAN GROUP DMEGC MAGNETICS CO., LTD, Dongyang City Jinhua, Zhejiang (CN)

(72) Inventors: Junwu NIE, Dongyang City Jinhua, Zhejiang (CN); Yangzhong DU, Dongyang City Jinhua, Zhejiang (CN); Suping WANG, Dongyang City Jinhua, Zhejiang (CN); Qian CHEN, Dongyang City Jinhua, Zhejiang (CN); Chun WANG, Dongyang City Jinhua, Zhejiang (CN)

(21) Appl. No.: 18/705,964

(22) PCT Filed: Jun. 29, 2023
(86) PCT No.: PCT/CN2023/103905

§ 371 Date: Apr. 29, 2024

(30) Foreign Application Priority Data
Jun. 29, 2022 (CN) 202210756953.5

(51) Int. Cl. H01F 41/02; H01F 1/147; H01F 1/37

(52) U.S. Cl. CPC H01F 41/0266; H01F 1/14766; H01F 1/37; H01F 41/026

(57) ABSTRACT

The present application discloses an iron-silicon magnetic powder core, a preparation method therefor, and an inductor. The preparation method comprises the following steps: (1) mixing iron-silicon alloy magnetic powder and a surface treating agent to obtain a surface-treated magnetic powder; (2) mixing a passivator, a solvent and the surface-treated magnetic powder of step (1) to obtain a passivated magnetic powder; (3) carrying out organic insulation bonding on the passivated magnetic powder of step (2) to obtain a bonded magnetic powder; (4) mixing a release agent and the bonded magnetic powder of step (3) to obtain mixed magnetic powder material; and (5) carrying out compression molding and annealing treatment on the mixed magnetic powder material obtained in step (4) to obtain the iron-silicon magnetic powder core. The iron-silicon magnetic powder core obtained by means of the preparation method provided by the present application has improved insulation and reduced eddy current loss. The invention ameliorates the problem of rapid temperature increases as well as the problem of increased magnetic powder core wear and tear caused by said temperature increases.

### TECHNICAL FIELD

Examples of the present application relate to the field of soft magnetic alloy materials and powder metallurgy technology, for example, a preparation method for an iron-silicon magnetic powder core, and in particular, an iron-silicon magnetic powder core, a preparation method therefor, and an inductor.

### BACKGROUND

The alloy magnetic powder composed of two elements of iron and silicon and the magnetic powder core manufactured therefrom have been widely used in various fields such as alternating-current inductors, output inductors, inverter inductors for photovoltaic power supplies, and boost inductors for new energy charging piles due to high direct-current superposition characteristic, no noise, and low cost. With the demand of fast-charging and the development of power electronic technology, the power density is increased rapidly, and higher requirements are also put forward for magnetic inductance components, and especially, the load is increased and the direct-current superposition is improved, so that the iron-silicon magnetic core is required to withstand a larger current. The large current will cause the temperature of the magnetic core to rise rapidly, which will further increase the iron-silicon loss, and such cycles will eventually cause failure of magnetic cores.

The main process of metal soft magnetic powder cores is: mixing metal powder with an insulating material to form a layer of uniform and dense insulating material on the surface of the powder, drying the powder and then adding powder lubricant, and then molding a product with a desired shape in a mold of the press, and finally subjecting the product to a heat treatment under a certain atmosphere and a certain temperature to eliminate defects and excess non-magnetic substances in the product, and thereby the product with good comprehensive performance is obtained. From the above manufacturing process, it can be seen that the main factors affecting the magnetic core loss and the temperature characteristic are the iron-silicon magnetic powder and the used insulating material. The loss-temperature rise is a characteristic of the iron-silicon alloy, and the only way to change the temperature rise characteristic lies in the insulation material.

CN112530656A discloses a preparation method for a low-loss iron-silicon magnetic powder core, which comprises the following steps: alloy-melting, crushing, sieving, a surface treatment, insulation-coating, lubricant-adding, compression molding, a heat treatment, and a surface-coating treatment; in the sieving process, powder materials are proportioned according to a mass ratio of −325 mesh to −250 mesh to −120 mesh being 2:3:1; and the magnetic powder core is subjected to a surface coating treatment after the heat treatment. The main component of the low-loss iron-silicon magnetic powder core in this application is a binary iron-silicon alloy added with 0.22-0.25% of chromium and 0.08-0.15% of vanadium, and 6.7-7.0% of silicon, and a remainder of iron. For the iron-silicon magnetic powder core prepared in this application, the saturation magnetic flux density can reach 1.6 T or more, and the loss per unit volume Pcv at 50 kHz and 500 Gs can be as low as 125-135 mW/cm³, and the iron-silicon magnetic powder core of this application has advantages of high saturation magnetic flux density and low loss.

CN113299451A discloses an iron-silicon magnetic powder core coated with FeNi nanoparticle/epoxy resin composite, and the preparation method of the iron-silicon magnetic powder core comprises the following steps: powder-mixing, modification, insulation-coating, drying, compression molding, and a vacuum annealing treatment. In this application, the iron-silicon powder is used as the main body with a FeNi nanoparticle/epoxy resin coating layer constructed on the surface. Compared with related products, the obtained iron-silicon magnetic powder core has the advantages of low magnetic loss, high permeability, high product compactness, and low cost.

In the above technical solutions, the low loss of the magnetic powder core has been moderated. However, in CN112530656A, there exist the shortcomings of high molding pressure and complex particle size gradation of the powder; there exists the problem that the loss change after the temperature rise of the magnetic core is not sufficiently disclosed; in addition, the use of trace elements such as chromium, vanadium and other precious metals in iron-silicon alloy powder increases the cost; the technical problem of iron-silicon rusting is not solved, and the result of reducing raw material cost has not been achieved. In CN113299451A, the high-cost nano-FeNi material and special processes such as the drying process that requires a vacuum environment are used; in addition, the role of the FeNi material in this application is not fully described, the magnetic permeability of samples in examples is not significantly increased; meanwhile, the loss of the magnetic powder core obtained in this application is higher than the standard of the art, and has no obvious advantage, and the variation law of the loss with the increase of the magnetic core temperature is not explained.

Therefore, how to solve the problem that the loss of the magnetic core increases along with the increase of temperature is an urgent challenge in the field of soft magnetic alloy materials and powder metallurgy technology.

### SUMMARY

The following is a summary of the subject described herein. This summary is not intended to limit the protection scope of the claims.

To solve the above technical problems, examples of the present application provide an iron-silicon magnetic powder core, a preparation method therefor, and an inductor, and by enhancing the effect of passivation and insulation, the heat dissipation performance of the magnetic powder core is improved, and the problem that the magnetic powder core of iron-silicon alloys has high loss and rapid temperature rise is effectively solved.

In a first aspect, an example of the present application provides a preparation method for an iron-silicon magnetic powder core, and the preparation method comprises the following steps:
(1) mixing iron-silicon alloy magnetic powder and a surface-treating agent to obtain surface-treated magnetic powder;
(2) mixing a passivating agent, a solvent, and the surface-treated magnetic powder in step (1) to obtain passivated magnetic powder;
(3) subjecting the passivated magnetic powder in step (2) to organic insulation bonding to obtain bonded magnetic powder;
(4) mixing a release agent and the bonded magnetic powder in step (3) to obtain a mixed magnetic powder material; and
(5) subjecting the mixed magnetic powder material in step (4) to compression molding and an annealing treatment to obtain the iron-silicon magnetic powder core.

In the preparation method provided in the present application, by enhancing the effect of passivation and insulation, the trend of the loss increasing along with the temperature rise of the iron-silicon magnetic powder core is changed to remaining constantly or even slightly decreasing, solving the problem of loss increasing along with the temperature rise caused by the enlarged superposition.

The iron-silicon alloy magnetic powder provided in the present application is the common iron-silicon alloy magnetic powder in the art without specific limitations.

Preferably, the iron-silicon alloy magnetic powder in step (1) has a particle size range of 15-150 μm, which can be, for example, 15 μm, 50 μm, 100 μm, 125 μm, or 150 μm; however, the particle size range is not limited to the listed values, and other unlisted values within the numerical range are also applicable.

Preferably, in the iron-silicon alloy magnetic powder in step (1), a mass of iron-silicon alloy magnetic powder having a particle size range of 75-150 μm accounts for more than or equal to 40 wt % of the total mass, which can be, for example, 40 wt %, 45 wt %, 50 wt %, 55 wt %, or 65 wt %; however, the mass proportion is not limited to the listed values, and other unlisted values within the numerical range are also applicable.

Preferably, in the iron-silicon alloy magnetic powder in step (1), a mass of iron-silicon alloy magnetic powder having a particle size range of 15-35 μm accounts for more than or equal to 30% of the total mass, which can be, for example, 30 wt %, 40 wt %, 45 wt %, 50 wt %, or 55 wt %; however, the mass proportion is not limited to the listed values, and other unlisted values within the numerical range are also applicable.

The particle size range of the iron-silicon alloy magnetic powder provided in the present application increases the utilization ratio of low-cost materials.

Preferably, the surface-treating agent in step (1) comprises an organic aluminum aerosol.

The organic aluminum aerosol provided in the present application can effectively improve the surface condition of the iron-silicon alloy magnetic powder and thereby is conducive to the passivation treatment.

Preferably, a mass of the surface-treating agent in step (1) is 0.5-1.5 wt % of the iron-silicon alloy magnetic powder, which can be, for example, 0.5 wt %, 0.8 wt %, 1 wt %, 1.2 wt %, or 1.5 wt %; however, the mass is not limited to the listed values, and other unlisted values within the numerical range are also applicable.

Preferably, the preparation method further comprises drying after the mixing in step (1).

Preferably, the drying is performed at a temperature of 75-85° C., which can be, for example, 75° C., 78° C., 80° C., 82° C., or 85° C.; however, the temperature is not limited to the listed values, and other unlisted values within the numerical range are also applicable.

Preferably, the passivating agent in step (2) comprises a water-soluble inorganic material, preferably phosphoric acid and/or aluminum dihydrogen phosphate.

Preferably, a mass of the passivating agent in step (2) is 0.15-2.5 wt % of the iron-silicon alloy magnetic powder, which can be, for example, 0.15 wt %, 0.5 wt %, 0.8 wt %, 1 wt %, 1.2 wt %, 1.5 wt %, 2 wt %, or 2.5 wt %; however, the mass is not limited to the listed values, and other unlisted values within the numerical range are also applicable.

Preferably, the solvent in step (2) comprises deionized water.

Preferably, a mass of the solvent in step (2) is 1.5-3 times the mass of the passivating agent, which can be, for example, 1.5 times, 1.8 times, 2 times, 2.5 times, or 3 times; however, the mass is not limited to the listed values, and other unlisted values within the numerical range are also applicable.

Preferably, the preparation method further comprises drying after the mixing in step (2).

Preferably, the preparation method further comprises mixing a silane coupling agent and the passivated magnetic powder in step (2) before the organic insulation bonding in step (3).

The silane coupling agent provided in the present application is mixed with the passivated magnetic powder before the bonding, increasing the coating uniformity of a binder on the surface of the magnetic powder, which is conducive to enhancing the penetrating performance of the binder.

The silane coupling agent comprises any one or a combination of at least two of vinylsilane, aminosilane, or methacryloyloxy silane, and a typical but non-limiting combination comprises a combination of vinylsilane and aminosilane, a combination of aminosilane and methacryloyloxy silane, a combination of vinylsilane and methacryloyloxy silane, or a combination of vinylsilane, aminosilane, and methacryloyloxy silane.

The silane coupling agent provided in the present application can improve the filler in dispersity and bonding strength in the resin, improve the compatibility between the inorganic filler and the resin, and improve the mechanical performance, electrical performance, and weather resistance of the filler.

Preferably, a mass of the silane coupling agent is 0.15-0.5 wt % of the iron-silicon alloy magnetic powder, which can be, for example, 0.15 wt %, 0.2 wt %, 0.25 wt %, 0.3 wt %, 0.4 wt %, or 0.5 wt %; however, the mass is not limited to the listed values, and other unlisted values within the numerical range are also applicable.

Preferably, the organic insulation bonding in step (3) is: mixing a binder solution and the passivated magnetic powder in step (2), drying, and sieving.

Preferably, a binder in the binder solution comprises an organosilicon resin.

Preferably, the organosilicon resin comprises a heat-resistant silicone resin and/or a modified silicone resin, preferably, a polymethyl silicone resin and/or a polysilane silicone resin.

The organosilicon resin provided in the present application can improve the insulation performance of the powder, improve the compatibility between the inorganic filler and the resin, improve the powder moldability, and increase the density.

Preferably, a solvent in the binder solution comprises acetone.

Preferably, a mass of the binder in the binder solution is 0.3-1.5 wt % of the iron-silicon alloy magnetic powder, which can be, for example, 0.3 wt %, 0.4 wt %, 0.5 wt %, 0.8 wt %, 1 wt %, or 1.5 wt %; however, the mass is not limited to the listed values, and other unlisted values within the numerical range are also applicable.

Preferably, a mass of the solvent in the binder solution is 1-5 times the mass of the binder, which can be, for example, 1 time, 2 times, 3 times, 4 times, or 5 times; however, the mass is not limited to the listed values, and other unlisted values within the numerical range are also applicable.

Preferably, the sieving is performed at a size of 80-200 mesh, which can be, for example, 80 mesh, 100 mesh, 150 mesh, 180 mesh, or 200 mesh; however, the size is not limited to the listed values, and other unlisted values within the numerical range are also applicable.

Preferably, the release agent in step (4) comprises zinc stearate.

Preferably, a mass of the release agent in step (4) is 0.3-0.5 wt % of the iron-silicon alloy magnetic powder, which can be, for example, 0.3 wt %, 0.35 wt %, 0.4 wt %, 0.45 wt %, or 0.5 wt %; however, the mass is not limited to the listed values, and other unlisted values within the numerical range are also applicable.

Preferably, the compression molding in step (5) is performed at a pressure of 1500-1800 MPa, which can be, for example, 1500 MPa, 1550 MPa, 1600 MPa, 1700 MPa, or 1800 MPa; however, the pressure is not limited to the listed values, and other unlisted values within the numerical range are also applicable.

Preferably, a maximum temperature of the annealing treatment in step (5) is 680-730° C., which can be, for example, 680° C., 690° C., 700° C., 710° C., 720° C., or 730° C.; however, the maximum temperature is not limited to the listed values, and other unlisted values within the numerical range are also applicable.

Preferably, the annealing treatment in step (5) is performed with a temperature-holding period of 25-35 min, which can be, for example, 25 min, 28 min, 30 min, 32 min, or 35 min; however, the temperature-holding period is not limited to the listed values, and other unlisted values within the numerical range are also applicable.

Preferably, the preparation method further comprises cooling and applying a coating layer after the annealing treatment in step (5).

Preferably, a coating material of the coating layer comprises an epoxy resin.

As a preferred technical solution of the preparation method in the first aspect of the present application, the preparation method comprises the following steps:
(1) mixing iron-silicon alloy magnetic powder and an organic aluminum aerosol, and drying at 75-85° C. to obtain surface-treated magnetic powder; a mass of the organic aluminum aerosol is 0.5-1.5 wt % of the iron-silicon alloy magnetic powder;
(2) mixing a passivating agent, deionized water, and the surface-treated magnetic powder in step (1), and drying to obtain passivated magnetic powder; the passivating agent is 0.15-2.5 wt % of the iron-silicon alloy magnetic powder, and a mass of the deionized water is 1.5-3 times a mass of the passivating agent; the passivating agent is phosphoric acid and/or aluminum dihydrogen phosphate;
(3) mixing a silane coupling agent having a mass being 0.15-0.5 wt % of the iron-silicon alloy magnetic powder and the passivated magnetic powder in step (2), then mixing with a solution containing an organosilicon resin and acetone, drying, and sieving with a screen having a size of 80-200 mesh to obtain bonded magnetic powder; a mass of the organosilicon resin is 0.3-1.5 wt % of the iron-silicon alloy magnetic powder, and a mass of the acetone is 1-5 times the mass of the organosilicon resin;
(4) mixing zinc stearate having a mass being 0.3-0.5 wt % of the iron-silicon alloy magnetic powder and the bonded magnetic powder in step (3) to obtain a mixed magnetic powder material; and
(5) subjecting the mixed magnetic powder material in step (4) to compression molding at a pressure of 1500-1800 MPa, and then performing an annealing treatment with a maximum temperature of 680-730° C., and holding the temperature for a period of 25-35 min, cooling and then coating an epoxy resin layer to obtain the iron-silicon magnetic powder core;
in the iron-silicon alloy magnetic powder in step (1), a mass of iron-silicon alloy magnetic powder having a particle size range of 75-150 μm accounts for more than or equal to 40 wt % of the total mass, a mass of iron-silicon alloy magnetic powder having a particle size range of 15-35 μm accounts for more than or equal to 30% of the total mass, and the remaining has a particle size range of 35-75 μm.

In a second aspect, an example of the present application provides an iron-silicon magnetic powder core, and the iron-silicon magnetic powder core is obtained by the preparation method according to the first aspect.

In a third aspect, an example of the present application provides an inductor containing the iron-silicon magnetic powder core according to the second aspect.

Compared with the related art, the examples of the present application have at least the following beneficial effects.
(1) For the iron-silicon magnetic powder core obtained by the preparation method provided in the examples of the present application, the effect of passivation and insulation is improved, the eddy current loss is reduced, and the problems that the loss of the magnetic powder core is increased along with temperature rise and the temperature rise is too fast are eased.
(2) The preparation method provided in the examples of the present application has a simple process and low requirements on equipment, and reduces the material cost.

Other aspects can be understood upon reading and appreciating the detailed description.

### DETAILED DESCRIPTION

To facilitate understanding the present application, examples are listed below in the present application. Those skilled in the art should understand that the examples merely assist in understanding the present application but should not be regarded as a specific limitation of the present application.

### Example 1

This example provides a preparation method for an iron-silicon magnetic powder core, and the preparation method comprises the following steps:
(1) iron-silicon alloy magnetic powder (with a silicon content of 5 wt % and a remainder of iron) and an organic aluminum aerosol (Changhe JR14W, nano-aluminum aerosol) with a mass of 1 wt % of the iron-silicon alloy magnetic powder were mixed, and dried at 80° C. to obtain surface-treated magnetic powder;
in the iron-silicon alloy magnetic powder, a mass of iron-silicon alloy magnetic powder having a particle size range of 75-150 μm accounted for 40 wt % of the total mass, a mass of iron-silicon alloy magnetic powder having a particle size range of 15-35 μm accounted for 30% of the total mass, and the remaining had a particle size range of 35-75 μm;
(2) phosphoric acid, deionized water, and the surface-treated magnetic powder in step (1) were mixed, and dried to obtain passivated magnetic powder;
a mass of the phosphoric acid was 1 wt % of the iron-silicon alloy magnetic powder; a mass of the deionized water was 2 times the mass of the phosphoric acid;
(3) a vinyl silane coupling agent with a mass of 0.25 wt % of the iron-silicon alloy magnetic powder was added into the passivated magnetic powder in step (2), then mixed with a solution containing an organosilicon resin (FJN-9802 high-temperature organosilicon made in China) and acetone, dried and sieved with a 100-mesh screen to obtain bonded magnetic powder;
a mass of the organosilicon resin was 1 wt % of the iron-silicon alloy magnetic powder, and a mass of the acetone was 3 times the mass of the organosilicon resin;
(4) zinc stearate with a mass of 0.4 wt % of the iron-silicon alloy magnetic powder was mixed with the bonded magnetic powder in step (3) to obtain a mixed magnetic powder material; and
(5) the mixed magnetic powder material in step (4) was subjected to compression molding at a pressure of 1700 MPa, then annealed with a maximum temperature of 700° C. and a temperature-holding period of 30 min, cooled, and then coated with an epoxy resin layer to obtain the iron-silicon magnetic powder core.

### Example 2

This example provides a preparation method for an iron-silicon magnetic powder core, and the preparation method comprises the following steps:
(1) iron-silicon alloy magnetic powder (with a silicon content of 4.5 wt % and a remainder of iron) and an organic aluminum aerosol (Changhe JR14W, nano-aluminum aerosol) with a mass of 0.5 wt % of the iron-silicon alloy magnetic powder were mixed, and dried at 85° C. to obtain surface-treated magnetic powder;
in the iron-silicon alloy magnetic powder, a mass of iron-silicon alloy magnetic powder having a particle size range of 75-150 μm accounted for 45 wt % of the total mass, a mass of iron-silicon alloy magnetic powder having a particle size range of 15-35 μm accounted for 35% of the total mass, and the remaining had a particle size range of 35-75 μm;
(2) aluminum dihydrogen phosphate, deionized water, and the surface-treated magnetic powder in step (1) were mixed, and dried to obtain passivated magnetic powder;
a mass of the aluminum dihydrogen phosphate was 0.15 wt % of the iron-silicon alloy magnetic powder; a mass of the deionized water was 1.5 times the mass of the aluminum dihydrogen phosphate;
(3) an amino silane coupling agent with a mass of 0.15 wt % of the iron-silicon alloy magnetic powder was added into the passivated magnetic powder in step (2), then mixed with a solution containing a polymethyl silicon resin and acetone, dried and sieved with a 80-mesh screen to obtain bonded magnetic powder;
a mass of the polymethyl silicon resin was 0.3 wt % of the iron-silicon alloy magnetic powder, and a mass of the acetone was 1 times the mass of the polymethyl silicon resin;
(4) zinc stearate with a mass of 0.3 wt % of the iron-silicon alloy magnetic powder was mixed with the bonded magnetic powder in step (3) to obtain a mixed magnetic powder material; and
(5) the mixed magnetic powder material in step (4) was subjected to compression molding at a pressure of 1500 MPa, then annealed with a maximum temperature of 730° C. and a temperature-holding period of 25 min, cooled, and then coated with an epoxy resin layer to obtain the iron-silicon magnetic powder core.

### Example 3

This example provides a preparation method for an iron-silicon magnetic powder core, and the preparation method comprises the following steps:
(1) iron-silicon alloy magnetic powder (with a silicon content of 6.5 wt % and a remainder of iron) and an organic aluminum aerosol (Changhe JR14W, nano-aluminum aerosol) with a mass of 1.5 wt % of the iron-silicon alloy magnetic powder were mixed, and dried at 75° C. to obtain surface-treated magnetic powder;
in the iron-silicon alloy magnetic powder, a mass of iron-silicon alloy magnetic powder having a particle size range of 75-150 μm accounted for 42 wt % of the total mass, a mass of iron-silicon alloy magnetic powder having a particle size range of 15-35 μm accounted for 32% of the total mass, and the remaining had a particle size range of 35-75 μm;
(2) phosphoric acid, deionized water, and the surface-treated magnetic powder in step (1) were mixed, and dried to obtain passivated magnetic powder;
a mass of the phosphoric acid was 2.5 wt % of the iron-silicon alloy magnetic powder; a mass of the deionized water was 3 times the mass of the phosphoric acid;
(3) a methacryloyloxy silane coupling agent with a mass of 0.5 wt % of the iron-silicon alloy magnetic powder was added into the passivated magnetic powder in step (2), and then mixed with a solution containing a polysilane silicon resin and acetone, dried and sieved with a 200-mesh screen to obtain bonded magnetic powder;
a mass of the polysilane silicon resin was 1.5 wt % of the iron-silicon alloy magnetic powder, and a mass of the acetone was 5 times the mass of the organosilicon resin;
(4) zinc stearate with a mass of 0.5 wt % of the iron-silicon alloy magnetic powder was mixed with the bonded magnetic powder in step (3) to obtain a mixed magnetic powder material; and
(5) the mixed magnetic powder material in step (4) was subjected to compression molding at a pressure of 1800 MPa, then annealed with a maximum temperature of 680° C. and a temperature-holding period of 35 min, cooled, and then coated with an epoxy resin layer to obtain the iron-silicon magnetic powder core.

### Example 4

This example provides a preparation method for an iron-silicon magnetic powder core. This example differs from Example 1 only in that in the iron-silicon alloy magnetic powder in step (1), a mass of iron-silicon alloy magnetic powder having a particle size range of 75-150 μm accounted for 30 wt % of the total mass, a mass of iron-silicon alloy magnetic powder having a particle size range of 15-35 μm accounted for 30% of the total mass, and the remaining had a particle size range of 35-75 μm.

### Example 5

This example provides a preparation method for an iron-silicon magnetic powder core. This example differs from Example 1 only in that in the iron-silicon alloy magnetic powder in step (1), a mass of iron-silicon alloy magnetic powder having a particle size range of 75-150 μm accounted for 40 wt % of the total mass, a mass of iron-silicon alloy magnetic powder having a particle size range of 15-35 μm accounted for 20% of the total mass, and the remaining had a particle size range of 35-75 μm.

### Example 6

This example provides a preparation method for an iron-silicon magnetic powder core. This example differs from Example 1 only in that a mass of the phosphoric acid in step (2) was 0.1 wt % of the iron-silicon alloy magnetic powder.

### Example 7

This example provides a preparation method for an iron-silicon magnetic powder core. This example differs from Example 1 only in that a mass of the phosphoric acid in step (2) was 2.8 wt % of the iron-silicon alloy magnetic powder.

### Example 8

This example provides a preparation method for an iron-silicon magnetic powder core. This example differs from Example 1 only in that in step (3), the mixing operation of a silane coupling agent was not performed before a solution containing an organosilicon resin and acetone was mixed.

### Example 9

This example provides a preparation method for an iron-silicon magnetic powder core. This example differs from Example 1 only in that a mass of the silane coupling agent in step (3) was 0.1 wt % of the iron-silicon alloy magnetic powder.

### Example 10

This example provides a preparation method for an iron-silicon magnetic powder core. This example differs from Example 1 only in that a mass of the silane coupling agent in step (3) was 0.7 wt % of the iron-silicon alloy magnetic powder.

### Example 11

This example provides a preparation method for an iron-silicon magnetic powder core. This example differs from Example 1 only in that a mass of the organosilicon resin in step (3) was 0.2 wt % of the iron-silicon alloy magnetic powder.

### Example 12

This example provides a preparation method for an iron-silicon magnetic powder core. This example differs from Example 1 only in that a mass of the organosilicon resin in step (3) was 1.8 wt % of the iron-silicon alloy magnetic powder.

### Comparative Example 1

This comparative example provides a preparation method for an iron-silicon magnetic powder core. This comparative example differs from Example 1 only in that the organosilicon resin in step (3) was replaced by glass powder with an equal mass (Any T800 Glass Powder).

### Comparative Example 2

This comparative example provides a preparation method for an iron-silicon magnetic powder core. This comparative example differs from Example 1 only in that the organosilicon resin in step (3) was replaced by silicon dioxide with an equal mass.

The above obtained iron-silicon magnetic powder cores were tested.

Inductor test condition: the number of wire wound was 20 turns, and the frequency was 100 kHz.

Loss test condition: 50 kHz, a load of 100 mT.

Test temperature: 25° C., 50° C., 100° C., and 150° C.

The wire was wound by 22 turns+22 turns, and input and output had the same winding direction.

The test results are shown in Table 1 and Table 2 below.

TABLE 1

| | |
|---|---|
| 100 KHz/0.05 | 200 KHz/0.05 |
| V/20Ts/φ = 0.4 mm | V/20Ts/φ = 0.4 mm |

| Test No. | Ls (uH) | Q | Ls | Q |
|---|---|---|---|---|
| Example 1 | 33.16 | 121 | 33.04 | 80 |
| Example 2 | 33.18 | 121 | 33.05 | 80 |
| Example 3 | 34.29 | 121 | 34.17 | 80 |
| Example 4 | 34.12 | 121 | 34.01 | 80 |
| Example 5 | 34.78 | 121 | 34.66 | 80 |
| Example 6 | 34.76 | 121 | 34.52 | 80 |
| Example 7 | 29.22 | 111 | 29.11 | 79 |
| Example 8 | 33.55 | 118 | 33.32 | 80 |
| Example 9 | 25.67 | 108 | 25.35 | 79 |
| Example 10 | 32.63 | 120 | 32.52 | 80 |
| Example 11 | 33.32 | 119 | 33.12 | 80 |
| Example 12 | 26.76 | 109 | 26.54 | 77 |
| Comparative | 30.22 | 101 | 30.44 | 76 |
| Example 1 | | | | |
| Comparative | 30.42 | 101 | 30.56 | 76 |
| Example 2 | | | | |

TABLE 2

| | Loss | | | |
|---|---|---|---|---|
| | (mW/cm³, | | | |
| Test No. | 25° C.) | 50° C. | 100° C. | 150° C. |
| Example 1 | 521.12 | 516.77 | 512.47 | 511.22 |
| Example 2 | 508.40 | 507.57 | 507.52 | 503.49 |
| Example 3 | 512.46 | 510.45 | 510.43 | 507.35 |
| Example 4 | 535.11 | 534.28 | 528.76 | 520.63 |
| Example 5 | 528.14 | 524.18 | 523.87 | 519.09 |
| Example 6 | 531.31 | 530.45 | 528.29 | 525.13 |
| Example 7 | 553.45 | 553.21 | 550.23 | 545.78 |
| Example 8 | 529.89 | 528.77 | 524.81 | 519.23 |
| Example 9 | 533.23 | 530.25 | 528.78 | 525.67 |
| Example 10 | 535.78 | 530.58 | 527.48 | 519.06 |
| Example 11 | 543.72 | 539.57 | 530.74 | 521.43 |
| Example 12 | 574.32 | 572.62 | 570.11 | 571.04 |
| Comparative | 521.78 | 535.30 | 539.91 | 542.39 |
| Example 1 | | | | |
| Comparative | 514.52 | 527.47 | 534.20 | 537.27 |
| Example 2 | | | | |

The following conclusions can be obtained from Table 1 and Table 2.
(1) It can be seen from Examples 1-3 that for the iron-silicon magnetic powder core obtained by the preparation method provided by the present application, the effect of passivation and insulation is improved, the eddy current loss is reduced, and the problems that the loss of the magnetic powder core is increased along with temperature rise and the temperature rise is too fast are eased.
(2) It can be seen from the comparison of Examples 4-5 and Example 1 that in a case where the particle size range of the iron-silicon alloy magnetic powder is changed and exceeds the preferred range in the present application, the magnetic powder core has an increased loss and a reduced quality, and at the same time, increasing the amount of the magnetic powder core of 35-75 μm increases the preparation cost.
(3) It can be seen from the comparison of Examples 6-7 and Example 1 that in a case where the mass of the passivating agent in step (2) is changed and exceeds the preferred range in the present application, the loss of the magnetic powder core is increased, and the inductance and quality of the magnetic powder core are reduced.
(4) It can be seen from the comparison of Example 8 and Example 1 that in a case where the silane coupling agent is not added in step (3), the loss of the magnetic powder core is increased, and the quality of magnetic powder core is reduced.
(5) It can be seen from the comparison of Examples 9-10 and Example 1 that in a case where the mass of the silane coupling agent in step (3) is not within the preferred range in the present application, the inductance and quality of the magnetic powder core are reduced, and the loss of the magnetic powder core is increased.
(6) It can be seen from the comparison of Examples 11-12 and Example 1 that in a case where the mass of the organosilicon resin in step (3) is not within the preferred range in the present application, the inductance and quality of the magnetic powder core are reduced, and the loss of the magnetic powder core is increased.
(7) It can be seen from the comparison of Comparative Examples 1-2 and Example 1 that in a case where the organic bonding is replaced by the inorganic bonding in step (3), the inductance and quality of the magnetic powder core are reduced, and the problem of loss increasing along with the temperature rise of the iron-silicon magnetic powder core cannot be solved

In summary, for the iron-silicon magnetic powder core obtained by the preparation method provided by the present application, the effect of passivation and insulation is improved, the eddy current loss is reduced, and the problems that the loss of the magnetic powder core is increased along with temperature rise and the temperature rise is too fast are eased. Additionally, the preparation method provided by the present application has a simple process and low requirements on equipment, and reduces the material cost.

The detailed process flow in the present application is illustrated by the above examples of the present application, but the present application is not limited to the above detailed process flow, that is, the present application does not necessarily rely on the above detailed process flow to be implemented. Those skilled in the art should understand that any improvement of the present application, the equivalent substitution of each raw material of products, the addition of auxiliary ingredients, and the selection of specific methods in the present application shall fall within the protection scope and disclosure scope of the present application.

What is claimed is:

1. A preparation method for an iron-silicon magnetic powder core, comprising the following steps:
(1) mixing iron-silicon alloy magnetic powder and a surface-treating agent to obtain surface-treated magnetic powder;
(2) mixing a passivating agent, a solvent, and the surface-treated magnetic powder in step (1) to obtain passivated magnetic powder;
(3) subjecting the passivated magnetic powder in step (2) to organic insulation bonding to obtain bonded magnetic powder;
(4) mixing a release agent and the bonded magnetic powder in step (3) to obtain a mixed magnetic powder material; and
(5) subjecting the mixed magnetic powder material in step (4) to compression molding and an annealing treatment to obtain the iron-silicon magnetic powder core.

2. The preparation method according to claim 1, wherein the iron-silicon alloy magnetic powder in step (1) has a particle size range of 15-150 μm.

3. The preparation method according to claim 1, wherein in the iron-silicon alloy magnetic powder in step (1), a mass of iron-silicon alloy magnetic powder having a particle size range of 75-150 μm accounts for more than or equal to 40 wt % of the total mass.

4. The preparation method according to any one of claim 1, wherein in the iron-silicon alloy magnetic powder in step (1), a mass of iron-silicon alloy magnetic powder having a particle size range of 15-35 μm accounts for more than or equal to 30% of the total mass.

5. The preparation method according to any one of claim 1, wherein the surface-treating agent in step (1) comprises an organic aluminum aerosol;
preferably, a mass of the surface-treating agent in step (1) is 0.5-1.5 wt % of the iron-silicon alloy magnetic powder;
preferably, the preparation method further comprises drying after the mixing in step (1);
preferably, the drying is performed at a temperature of 75-85° C.

6. The preparation method according to any one of claim 1, wherein the passivating agent in step (2) comprises a water-soluble inorganic material, preferably phosphoric acid and/or aluminum dihydrogen phosphate;
preferably, a mass of the passivating agent in step (2) is 0.15-2.5 wt % of the iron-silicon alloy magnetic powder;
preferably, the solvent in step (2) comprises deionized water;
preferably, a mass of the solvent in step (2) is 1.5-3 times the mass of the passivating agent;
preferably, the preparation method further comprises drying after the mixing in step (2).

7. The preparation method according to any one of claim 1, wherein the preparation method further comprises mixing a silane coupling agent and the passivated magnetic powder in step (2) before the organic insulation bonding in step (3);
preferably, a mass of the silane coupling agent is 0.15-0.5 wt % of the iron-silicon alloy magnetic powder;
preferably, the organic insulation bonding in step (3) is: mixing a binder solution and the passivated magnetic powder in step (2), drying, and sieving;
preferably, a binder in the binder solution comprises an organosilicon resin;
preferably, a solvent in the binder solution comprises acetone;
preferably, a mass of the binder in the binder solution is 0.3-1.5 wt % of the iron-silicon alloy magnetic powder;
preferably, in the binder solution, a mass of the solvent is 1-5 times the mass of the binder;
preferably, the sieving is performed at a size of 80-200 mesh.

8. The preparation method according to any one of claim 1, wherein the release agent in step (4) comprises zinc stearate;
preferably, a mass of the release agent in step (4) is 0.3-0.5 wt % of the iron-silicon alloy magnetic powder.

9. The preparation method according to any one of claim 1, wherein the compression molding in step (5) is performed at a pressure of 1500-1800 MPa;
preferably, a maximum temperature of the annealing treatment in step (5) is 680-730° C.;
preferably, the annealing treatment in step (5) is performed with a temperature-holding period of 25-35 min.

10. The preparation method according to any one of claim 1, wherein the preparation method further comprises cooling and applying a coating layer after the annealing treatment in step (5);
preferably, a coating material of the coating layer comprises an epoxy resin.

11. The preparation method according to any one of claim 1, comprising the following steps:
(1) mixing iron-silicon alloy magnetic powder and an organic aluminum aerosol, and drying at 75-85° C. to obtain surface-treated magnetic powder; a mass of the organic aluminum aerosol is 0.5-1.5 wt % of the iron-silicon alloy magnetic powder;
(2) mixing a passivating agent, deionized water, and the surface-treated magnetic powder in step (1), and drying to obtain passivated magnetic powder; the passivating agent is 0.15-2.5 wt % of the iron-silicon alloy magnetic powder, and a mass of the deionized water is 1.5-3 times a mass of the passivating agent; the passivating agent is phosphoric acid and/or aluminum dihydrogen phosphate;
(3) mixing a silane coupling agent having a mass being 0.15-0.5 wt % of the iron-silicon alloy magnetic powder and the passivated magnetic powder in step (2), then mixing with a solution containing an organosilicon resin and acetone, drying, and sieving with a screen having a size of 80-200 mesh to obtain bonded magnetic powder; a mass of the organosilicon resin is 0.3-1.5 wt % of the iron-silicon alloy magnetic powder, and a mass of the acetone is 1-5 times the mass of the organosilicon resin;
(4) mixing zinc stearate having a mass being 0.3-0.5 wt % of the iron-silicon alloy magnetic powder and the bonded magnetic powder in step (3) to obtain a mixed magnetic powder material; and
(5) subjecting the mixed magnetic powder material in step (4) to compression molding at a pressure of 1500-1800 MPa, and then performing an annealing treatment with a maximum temperature of 680-730° C., and holding the temperature for a period of 25-35 min, cooling and then coating an epoxy resin layer to obtain the iron-silicon magnetic powder core;
in the iron-silicon alloy magnetic powder in step (1), a mass of iron-silicon alloy magnetic powder having a particle size range of 75-150 μm accounts for more than or equal to 40 wt % of the total mass, a mass of iron-silicon alloy magnetic powder having a particle size range of 15-35 μm accounts for more than or equal to 30% of the total mass, and the remaining has a particle size range of 35-75 μm.

12. An iron-silicon magnetic powder core, which is obtained by the preparation method according to any one of claim 1.

13. An inductor, which contains the iron-silicon magnetic powder core according to claim 12.
